(19) United States
(12) Patent Application Publication
(10) Pub. No.: US 2026/0298243 A1
(43) Pub. Date: Oct. 1, 2026

(54) VERTICAL TURBINE PUMP WITH ROLLER BEARING SUPPORT

(71) Applicant: Unted Flo, LLC, Addison, IL (US)

(72) Inventors: Radosav Trninich, Elmhurst, IL (US); Jason Sexton, Aurora, IL (US)

(21) Appl. No.: 19/578,221

(22) Filed: Mar. 25, 2026

Related U.S. Application Data
(60) Provisional application No. 63/777,469, filed on Mar. 25, 2025.

(51) Int. Cl. F04D 1/00; F04D 29/049; F04D 29/08; F16C 19/38; F16C 33/76

(52) U.S. Cl. CPC F04D 1/00; F04D 29/049; F04D 29/086; F16C 19/38; F16C 33/76; F16C 2360/44

(57) ABSTRACT

A vertical turbine pump having a bowl assembly configured to be positioned in a fluid source, an impeller assembly disposed in the bowl assembly, and a shaft coupled to the impeller assembly. The shaft extends through a bearing region in which at least one roller bearing rotatably supports the shaft during operation. A seal assembly is arranged to inhibit pumped fluid from entering the bearing region such that the bearing region is maintained in a substantially dry condition. In certain implementations, the pump may include a bearing housing defining a dry column, a mechanical seal positioned between the bowl assembly and the dry column, and a plurality of roller bearings spaced along the shaft. The arrangement may reduce bearing exposure to pumped fluid, improve shaft alignment and load support, reduce friction and wear, and improve durability and operating efficiency relative to conventional vertical turbine pumps using fluid-exposed bearing arrangements.

### CLAIM OF PRIORITY

This application claims the benefit of United States Provisional Patent Application 63/777,469 filed on Mar. 25, 2025, which is incorporated by reference herein in its entirety.

### BACKGROUND OF THE INVENTION

### FIELD OF THE INVENTION

The present invention relates generally to pumping systems for lifting fluids from wells, reservoirs, and other submerged sources. More particularly, the present invention relates to vertical turbine pumps having a rotatable shaft and impeller assembly arranged within a vertically extending pump structure. Still more particularly, the present invention relates to a vertical turbine pump configured to isolate a bearing region from pumped fluid by forming a dry column and to support the rotating shaft with roller bearings positioned within the dry column.

### DESCRIPTION OF THE RELATED ART

Vertical turbine pumps have long been used in applications in which water or other fluids must be lifted from a source located below grade or otherwise below an installation surface. Such pumps are commonly used in agricultural irrigation systems, municipal water supply systems, industrial water handling systems, and deep-well extraction environments. In many of these settings, the pump must operate over extended periods of time while maintaining consistent hydraulic performance, reliable shaft rotation, and sufficient structural integrity to withstand both radial and axial loads generated during operation. Because the pump is often positioned deep within a well or other submerged environment, the pump is also expected to operate with minimal maintenance and with a high degree of dependability. These operating demands place significant importance on the design of the rotating assembly, the bearing support arrangement, and the manner in which the pump manages interaction between moving components and the pumped fluid.

Conventional vertical turbine pump arrangements generally include a lower bowl assembly, one or more impellers coupled to a rotating shaft, a column assembly extending upwardly from the bowl assembly, and a drive arrangement located at or near the installation surface. The rotating shaft transfers torque from a motor or other driver to the impeller so that the impeller may impart energy to the fluid and urge the fluid upwardly through the pump and into a discharge system. In many known constructions, the shaft extends through a fluid-exposed environment along at least a substantial portion of the pump length. In order to maintain shaft position and provide support during rotation, conventional systems frequently rely on journal bearings, sleeve bearings, plain bearings, or similar support components positioned along the shaft path. In many such pumps, these bearing components are lubricated by the pumped liquid itself, such that the water or other fluid surrounding the shaft is also relied upon to provide the lubrication needed for continued bearing operation.

Although this general approach has been used for many years, it is associated with a number of practical limitations. One recurring issue is that a bearing arrangement dependent upon direct exposure to pumped fluid may be subject to inconsistent lubrication conditions. The characteristics of the pumped water may vary substantially from one installation to another and even over time within the same installation. For example, fluid may contain abrasives, dissolved minerals, entrained solids, biological matter, chemical contaminants, or other constituents that adversely affect the bearing surfaces. Even where the fluid is nominally clean, the fluid may not provide optimal lubrication characteristics for maintaining low-friction rotational support over long service intervals. As a result, conventional fluid-exposed bearing systems may experience accelerated wear, degradation of bearing surfaces, and loss of efficiency over time.

Another concern with conventional arrangements is that direct exposure of the bearing region to pumped fluid may promote corrosion, erosion, or material breakdown. Vertical turbine pumps are often expected to operate in wells or environments where water chemistry is not tightly controlled. Groundwater composition can vary significantly, and certain installations may expose internal pump components to corrosive conditions for prolonged periods. Where bearings and adjacent shaft-support components are continuously contacted by such fluid, the system may be susceptible to material deterioration, dimensional changes, and shortened service life. Even a relatively small amount of degradation within the bearing region can adversely influence the alignment of the rotating assembly, which in turn can reduce hydraulic efficiency and increase the likelihood of secondary wear affecting neighboring parts.

Conventional bearing arrangements may also present limitations with respect to frictional losses. Journal-type supports, particularly those operating in fluid-exposed conditions, may generate higher friction than desired under certain load and speed conditions. Increased friction may translate into higher power consumption, greater heat generation, and less efficient transfer of input energy into useful hydraulic work. In applications such as agricultural irrigation or municipal pumping, where pumps may run for long intervals and consume substantial power, even modest inefficiencies can accumulate into significant operating costs. Accordingly, there has been an ongoing need for pump configurations that can reduce friction within the rotating support structure and thereby improve overall energy efficiency.

Precise positioning of the shaft and impeller assembly is also a significant consideration in vertical turbine pumps. The rotating assembly should remain properly aligned relative to surrounding pump structures in order to maintain smooth rotation, preserve intended running clearances, and support effective fluid movement through the bowl and diffuser components. However, conventional support arrangements may permit undesirable deflection, positional drift, or uneven support under demanding operating conditions. Misalignment may lead to inefficient impeller operation, increased wear at close-clearance regions, unwanted contact between rotating and stationary parts, vibration, and reduced pump life. The challenge becomes more pronounced in pumps that operate over substantial vertical lengths, include intermediate shaft sections, or are adapted for deeper installations, because support conditions along the rotating assembly may materially affect performance at the lower hydraulic end of the pump.

Maintenance considerations further illustrate deficiencies in existing systems. A vertical turbine pump installed in a deep well or other difficult-to-access location can be expensive and time-consuming to service. When conventional bearing systems wear prematurely, corrode, or lose performance due to prolonged exposure to pumped fluid, maintenance intervals may shorten and downtime may increase. In commercial, industrial, or municipal settings, such downtime may be especially problematic because interruption of water supply can affect irrigation schedules, production processes, cooling operations, or essential public services. A pump design that better protects critical support components and extends service life therefore offers substantial practical value.

Attempts to improve performance in vertical pumping equipment have often focused on changes to impeller geometry, materials of construction, or general pump staging arrangements. While such modifications may improve certain aspects of hydraulic operation, they do not necessarily address the persistent issues associated with fluid-exposed shaft support systems. In many conventional designs, the bearing environment remains fundamentally tied to the pumped liquid. As a result, the system continues to experience many of the same concerns relating to contamination, corrosion, frictional loss, inconsistent support, and reduced durability. There remains a need for a different structural approach in which the support arrangement for the rotating assembly is not wholly dependent upon direct contact with the pumped fluid.

A particular shortcoming of many existing vertical turbine pump constructions is that they do not provide an effectively isolated internal region in which higher-performance bearing technologies may be implemented. Where the bearing area is exposed to water, the designer is constrained in the selection of support components and lubrication strategies. This tends to favor conventional plain or journal-type bearings rather than bearings that may provide superior load handling and more precise rotational support but that are better suited for operation in a dry or otherwise protected environment. As a result, conventional pump design has often accepted limitations in support precision and frictional performance as a practical consequence of the fluid-exposed architecture.

There is therefore a need for a vertical turbine pump configuration capable of establishing a sealed region that isolates at least part of the rotating support assembly from the pumped fluid. A pump architecture of that kind would allow the bearing environment to be more carefully controlled and would create opportunities to use bearing structures that are not practical in conventional water-exposed systems. There is further a need for a pump in which the rotating shaft can be supported in a manner that provides improved load-bearing capability, reduced rotational friction, and better positional control of the impeller and shaft assembly. Such improvements would be expected to contribute to lower power consumption, smoother operation, improved hydraulic consistency, and a longer operational lifespan.

There is also a need for a pump arrangement that preserves compatibility with the broader structure of a vertical turbine pump while improving the support characteristics of the rotating assembly. In many applications, it is desirable for the pump to continue using known structural features such as a bowl assembly, diffuser components, a discharge arrangement, intermediate shaft sections, and column components adapted for various installation depths. At the same time, the pump should be capable of incorporating an improved support system that can be integrated into the lower assembly without requiring abandonment of the general benefits associated with vertical turbine pump architecture. A commercially practical solution should therefore be capable of use in deep-well extraction, irrigation, industrial transfer, and municipal water supply environments while addressing long-recognized shortcomings in conventional support arrangements.

Another need in the field is for a pump that can provide improved durability without imposing excessive complexity or sacrificing operational stability. Shaft support systems that are vulnerable to water-driven wear, corrosion, or inconsistent lubrication may lead not only to more frequent service but also to less predictable performance over the operating life of the pump. A more protected support arrangement would desirably reduce sensitivity to fluid quality and mitigate deterioration mechanisms associated with continuous liquid exposure. In addition, by better controlling shaft position and reducing friction, such a system could help maintain intended hydraulic relationships among the impeller, bowl, diffuser, and related flow-management components.

Accordingly, there exists a need in the art for an improved vertical turbine pump capable of addressing the shortcomings of conventional pumps that rely upon water-lubricated journal bearings or similar fluid-exposed support structures. There is a need for a pump configuration that better isolates critical support components from the pumped liquid, reduces frictional losses, improves load support, maintains more precise alignment of the rotating assembly, and extends useful operating life. There is further a need for such a configuration to be adaptable for use in a variety of pumping environments, including deep-well, agricultural, industrial, and municipal installations. The present invention satisfies these and other needs by providing an improved vertical turbine pump architecture incorporating a dry column and roller bearing support arrangement.

### SUMMARY OF THE INVENTION

The present invention relates to a vertical turbine pump having an improved shaft support arrangement configured to enhance pump operation and durability. More particularly, the present invention provides a vertical turbine pump in which a rotating shaft associated with one or more impellers is supported by one or more roller bearings rather than conventional plain bearings or water-lubricated journal bearings. In certain implementations, the pump may include a sealed or otherwise isolated bearing region configured to maintain the roller bearings in a substantially dry operating environment. By supporting the rotating assembly with roller bearings, the present invention may improve rotational stability, support axial and radial loads more effectively, and provide more precise positioning of the shaft and impeller assembly during operation. The present invention may be implemented in deep well, industrial, agricultural, municipal, and other pumping applications in which vertical turbine pumps are used to lift and discharge fluid.

The present invention provides a number of advantages over conventional vertical turbine pump arrangements. In contrast to prior systems that rely upon water-lubricated bearings exposed to the pumped fluid, the present invention may reduce friction, reduce wear, and reduce the adverse effects of contaminants, abrasive material, and corrosive constituents present in the fluid. The use of roller bearings may also provide improved load handling and improved shaft alignment, which may promote smoother rotation, improved hydraulic performance, reduced power consumption, and longer service life. In addition, by isolating the bearing support arrangement from the pumped liquid in certain implementations, the present invention may reduce maintenance demands and improve long-term reliability in difficult operating environments. Accordingly, the present invention addresses shortcomings associated with conventional vertical turbine pumps and provides a more robust and efficient pump structure.

In a first implementation of the present invention, a vertical turbine pump may comprise a bowl assembly configured to be positioned in a fluid source, an impeller assembly disposed in the bowl assembly, a shaft coupled to the impeller assembly and extending upwardly therefrom, a column assembly extending upwardly from the bowl assembly, a bearing housing disposed within the vertical turbine pump and defining a bearing region through which the shaft extends, at least one roller bearing positioned within the bearing region and configured to rotatably support the shaft, and a seal assembly arranged between the bearing region and the bowl assembly, the seal assembly being configured to inhibit pumped fluid from entering the bearing region, wherein rotation of the shaft drives the impeller assembly to pump fluid through the bowl assembly while the at least one roller bearing supports the shaft within the bearing region and the seal assembly maintains the bearing region in a substantially dry condition.

In another aspect, the seal assembly may comprise a mechanical seal.

In another aspect, the mechanical seal may be positioned adjacent the impeller assembly.

In another aspect, the bearing housing and the seal assembly may cooperate to define a dry column within the vertical turbine pump.

In another aspect, the at least one roller bearing may comprise a plurality of roller bearings positioned within the bearing region.

In another aspect, the plurality of roller bearings may include an upper roller bearing and a lower roller bearing spaced from one another along the shaft.

In another aspect, the plurality of roller bearings may be clamped in place within the bearing region.

In another aspect, the plurality of roller bearings may be secured within the bearing region by one or more threaded fasteners.

In another aspect, the seal assembly may be configured to isolate the bearing region from pumped water during operation of the vertical turbine pump.

In another aspect, the bearing region may be free of water-lubricated journal bearings.

In another aspect, the at least one roller bearing may be configured to support radial loads imparted to the shaft during operation of the vertical turbine pump.

In another aspect, the at least one roller bearing may be configured to support axial loads and radial loads imparted to the shaft during operation of the vertical turbine pump.

In another aspect, the at least one roller bearing may be configured to maintain positional control of the shaft and the impeller assembly during operation of the vertical turbine pump. In another aspect, the bowl assembly may comprise an impeller bowl configured to inhibit recirculation of fluid into a suction side of the impeller assembly.

In another aspect, the vertical turbine pump may further include a diffuser positioned to receive fluid discharged from the impeller assembly.

In another aspect, the vertical turbine pump may further include a straightener positioned above the diffuser and configured to smooth upward fluid flow through the vertical turbine pump.

In another aspect, the column assembly may comprise one or more modular column sections configured to accommodate different installation depths.

In another aspect, the vertical turbine pump may further include a driver adapter configured to couple the shaft to a motor.

In another implementation of the present invention, a vertical turbine pump may comprise a bowl assembly configured to be positioned in a fluid source, an impeller assembly disposed in the bowl assembly, a shaft coupled to the impeller assembly and extending upwardly therefrom, a column assembly extending upwardly from the bowl assembly, a bearing housing positioned above the bowl assembly and defining a dry column through which the shaft extends, an upper roller bearing and a lower roller bearing positioned within the dry column and spaced from one another along the shaft, the upper roller bearing and the lower roller bearing being configured to rotatably support the shaft, and a mechanical seal positioned between the bowl assembly and the dry column and disposed about the shaft, the mechanical seal being configured to inhibit pumped fluid from entering the dry column, wherein rotation of the shaft drives the impeller assembly to pump fluid upwardly through the bowl assembly while the upper roller bearing and the lower roller bearing support the shaft within the dry column in a substantially dry condition.

In another implementation of the present invention, a method of operating a vertical turbine pump may comprise positioning a bowl assembly and an impeller assembly in a fluid source, rotating a shaft coupled to the impeller assembly to drive the impeller assembly and thereby pump fluid upwardly through the vertical turbine pump, rotatably supporting the shaft with at least one roller bearing positioned within a bearing region of the vertical turbine pump, and inhibiting pumped fluid from entering the bearing region with a seal assembly arranged between the bearing region and the bowl assembly such that the at least one roller bearing remains in a substantially dry condition during operation of the vertical turbine pump.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1A is a side elevation view illustrating a vertical turbine pump according to one implementation of the present invention;

FIG. 1B is a sectional side view taken along line A-A of FIG. 1A, illustrating internal components of the vertical turbine pump of FIG. 1A; and

FIG. 2 is a perspective sectional view illustrating a lower vertical turbine assembly according to one implementation of the present invention.

Like reference numerals refer to like parts throughout the several views of the drawings.

### DETAILED DESCRIPTION OF THE PREFERRED EMBODIMENT

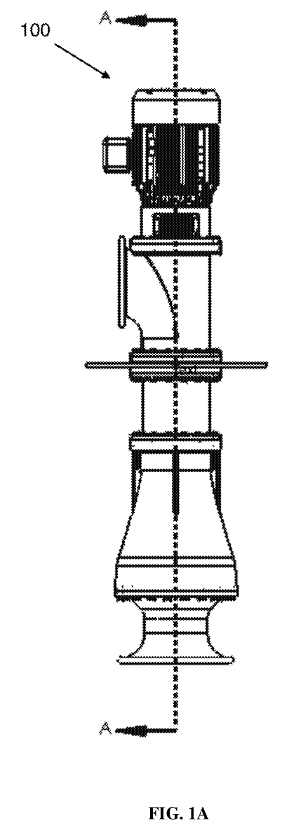

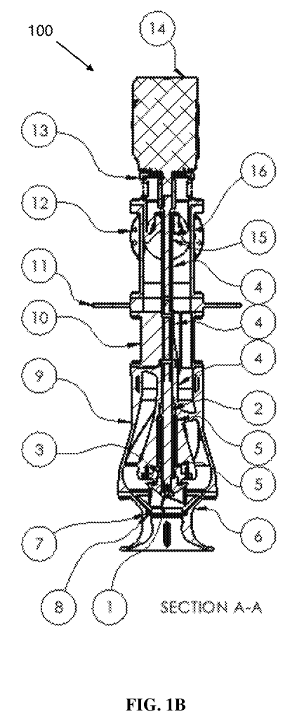

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. Accordingly, any dimensions, proportions, or relative sizes depicted in the drawings are provided for illustrative purposes only and may vary without departing from the scope of the claimed invention.

The present invention relates to a vertical turbine pump configured to lift water or other fluids from a submerged source while providing improved internal shaft support and improved isolation of bearing components from the pumped fluid. The vertical turbine pump may be used in agricultural irrigation systems, municipal water supply systems, industrial transfer systems, deep-well pumping systems, and other applications in which fluid is drawn upwardly through a vertically oriented pump assembly. In contrast to conventional vertical turbine pumps that may rely on water-lubricated journal bearings or other fluid-exposed support arrangements, the present invention may employ a dry bearing region and one or more roller bearings configured to support a rotating shaft in a substantially isolated environment. The pump may thereby reduce friction, improve shaft alignment, improve load handling, and reduce wear associated with contaminants, corrosion, or inconsistent lubrication conditions present in the pumped fluid. Such a configuration may improve operating efficiency, durability, and service life while maintaining compatibility with vertical turbine pump architectures used across a wide range of installation depths and pumping environments. The vertical turbine pump may be formed from metal, alloy, composite, polymeric, corrosion-resistant, wear-resistant, or mixed materials depending on the intended flow rate, head pressure, installation depth, fluid chemistry, solids content, and service conditions.

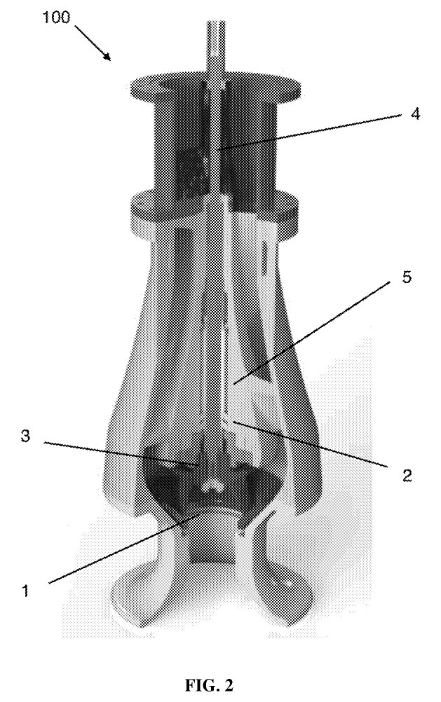

Referring now to FIGS. 1A-2, one implementation of the present invention may comprise a vertical turbine pump 100 configured to lift water or other fluids from a submerged source and deliver the fluid upwardly toward a discharge location. Vertical turbine pump 100 may be particularly suited for deep-well extraction, agricultural irrigation, industrial transfer, municipal water supply, and other applications in which a vertically arranged pumping system is positioned with a lower hydraulic end beneath grade or otherwise within a fluid source. As shown generally in FIG. 1A, vertical turbine pump 100 may comprise an elongated vertically extending assembly having a lower pumping portion, an intermediate column portion, and an upper drive portion. In the illustrated implementation, vertical turbine pump 100 may be arranged about a generally vertical central axis and may be configured such that rotational input applied at an upper end of the assembly is transmitted downwardly through a shaft arrangement to a lower impeller arrangement. The present invention may differ from conventional vertical turbine pump arrangements by providing a dry bearing environment and roller bearing support architecture that may isolate the bearing region from pumped fluid and may thereby improve friction characteristics, shaft support, alignment control, and service life. The illustrated configuration may therefore be understood as a vertical turbine pump 100 in which fluid-lift functionality is combined with an internal support arrangement designed to maintain one or more roller bearings in a substantially dry condition during operation.

As further shown in FIG. 1B, vertical turbine pump 100 may include an impeller 1 positioned in a lower portion of the pump and configured to impart energy to fluid entering the lower inlet region of the assembly. Impeller 1 may be coupled to a shaft 2 such that rotation of shaft 2 causes corresponding rotation of impeller 1. Shaft 2 may extend upwardly from impeller 1 through a lower pump section and into an upper column and drive region, thereby transmitting torque from an external driver to the hydraulic components of the pump. In some implementations, shaft 2 may be a one-piece shaft extending along a substantial vertical length of the pump, while in other implementations shaft 2 may comprise multiple aligned shaft portions coupled together, including one or more intermediate shaft sections 15 as described further below. The lower hydraulic portion of the pump may additionally include an impeller bowl 6 positioned around impeller 1. Impeller bowl 6 may define a surrounding fluid-handling structure that may guide incoming fluid toward impeller 1 and may inhibit undesired recirculation into the suction side of the impeller. The shape of impeller bowl 6 may vary depending on pump size, desired flow characteristics, fluid properties, and intended installation environment. In certain implementations, impeller 1 and impeller bowl 6 may be dimensioned and arranged to create a controlled hydraulic passage through which fluid is drawn upwardly in response to rotation of impeller 1.

In the illustrated arrangement, a mechanical seal 3 may be positioned behind or above impeller 1 relative to the primary flow direction of fluid through the pump. Mechanical seal 3 may be located at or near the transition region between the lower hydraulic portion of vertical turbine pump 100 and an isolated bearing-support region located above the impeller. Mechanical seal 3 may be configured to inhibit pumped fluid from migrating upwardly into a dry column 4. Dry column 4 may be defined within a bearing housing or internal column region through which shaft 2 extends, and dry column 4 may be configured to remain substantially isolated from the pumped fluid during operation of vertical turbine pump 100. In some implementations, mechanical seal 3 may comprise a conventional mechanical face seal, cartridge seal, segmented seal, multiple-part seal assembly, or another sealing structure capable of inhibiting fluid ingress into dry column 4. The disclosure is not limited to any particular seal geometry, provided that the seal structure may create or help maintain an isolated region suitable for supporting bearings outside the pumped-fluid environment. Mechanical seal 3 may therefore cooperate with surrounding pump structure to establish dry column 4 as a sealed or substantially sealed operating space through which shaft 2 passes while fluid being pumped by impeller 1 remains primarily below the seal interface.

The provision of dry column 4 may allow vertical turbine pump 100 to utilize one or more roller bearings 5 in a manner not typically associated with conventional water-lubricated vertical turbine pump constructions. Roller bearings 5 may be positioned within dry column 4 and may rotatably support shaft 2 during operation of vertical turbine pump 100. In the illustrated sectional representation of FIG. 1B, roller bearings 5 are shown in a lower portion of the dry support region associated with shaft 2, although additional or alternative bearing positions may be used. Roller bearings 5 may comprise radial bearings, thrust bearings, combination radial/thrust bearings, tapered roller bearings, cylindrical roller bearings, needle roller bearings, spherical roller bearings, or other rolling-element bearing structures suitable for the intended load profile. In some implementations, a plurality of roller bearings 5 may be spaced from one another along shaft 2 within dry column 4, and the plurality may comprise an upper roller bearing and a lower roller bearing arranged to provide both radial support and improved axial load management. The roller bearing arrangement may be clamped in place, retained by one or more threaded fasteners, supported in a bearing cartridge, mounted within an internal sleeve, or otherwise secured relative to the surrounding pump structure. By locating roller bearings 5 within dry column 4, vertical turbine pump 100 may reduce dependence on water-lubricated journal bearings and may instead utilize rolling-element support that may provide lower friction, improved load handling, and more precise shaft positioning.

FIG. 1B further illustrates that dry column 4 may extend upwardly through at least a portion of the lower and intermediate pump structure, thereby allowing shaft 2 to remain supported within an isolated region as fluid is pumped separately through surrounding hydraulic passages. In some implementations, the repeated callouts for dry column 4 in FIG. 1B may denote that the dry column may extend longitudinally through multiple aligned portions of the pump structure rather than being limited to a single localized cavity. Similarly, shaft 2 may pass centrally through dry column 4 while surrounding housings, support walls, and flow-guiding structures remain radially outward from the shaft path. The dry column may be sealed, vented, partially enclosed, pressure-balanced, or otherwise configured to maintain a bearing environment different from the pumped-fluid environment. The use of the term dry column does not require absolute absence of moisture in all implementations. Rather, dry column 4 may be understood as an isolated region in which pumped fluid is substantially inhibited from entering and in which the bearing support arrangement may operate independently of direct water lubrication. This arrangement may allow the bearing environment to be lubricated by grease, oil, prepacked lubrication, sealed rolling-element interfaces, or other non-water-based lubrication approaches.

As also shown in FIG. 1B, vertical turbine pump 100 may optionally include one or more wear rings 7, 8 associated with impeller 1 and impeller bowl 6. Wear ring 7 may be positioned at one interface region between impeller 1 and surrounding structure, and wear ring 8 may be positioned at another adjacent interface region. Wear rings 7, 8 may be replaceable surfaces configured to reduce direct wear on more substantial pump components when close-clearance regions experience fluid-driven abrasion or contact-related wear. In some implementations, wear rings 7, 8 may be formed from hardened metal, bronze, composite material, polymeric material, ceramic-containing material, or another wear-resistant substance suited to the intended service environment. The wear ring arrangement may protect impeller 1, impeller bowl 6, or both from erosion associated with suspended solids, high-velocity flow, cavitation-related effects, or other abrasive operating conditions. Although wear rings 7, 8 may be omitted in some implementations, the presence of such wear-control components may contribute to longer service life and maintain closer hydraulic tolerances within the lower pump assembly. Wear rings 7, 8 may also be sized to allow replacement during service without requiring replacement of larger cast or machined structural components.

Vertical turbine pump 100 may further include a diffuser 9 positioned above the lower impeller region and configured to receive fluid discharged from impeller 1. Diffuser 9 may redirect, stabilize, or otherwise manage fluid flow after the fluid has received energy from impeller 1. In some implementations, diffuser 9 may convert at least a portion of the velocity imparted by impeller 1 into pressure while guiding fluid toward an upward flow path. The diffuser geometry may vary depending on the number of stages, desired head, flow rate, and manufacturing considerations. In single-stage implementations, diffuser 9 may primarily manage discharge from a single impeller. In multi-stage implementations, additional impellers and corresponding diffusers may be stacked vertically to incrementally raise pressure and head. A straightener 10 may optionally be positioned above diffuser 9. Straightener 10 may comprise a guide structure, vane assembly, flow-conditioning component, or support element configured to smooth upward fluid flow through vertical turbine pump 100. In some implementations, straightener 10 may additionally provide internal structural support for dry column 4 or adjacent portions of the pump body. Diffuser 9 and straightener 10 may therefore cooperate to support upward fluid transport while keeping the hydraulic path sufficiently separated from the dry bearing-support environment.

The mounting and installation architecture of vertical turbine pump 100 may include a soleplate 11 positioned at an upper support region of the pump. Soleplate 11 may be configured to mount the pump to a rigid foundation, well head structure, platform, frame, or other support surface. In some implementations, soleplate 11 may establish installation depth and positional alignment of the pump relative to the source fluid. Soleplate 11 may comprise a plate, flange, ring, bracket structure, or another support interface having suitable stiffness to maintain the pump in its installed orientation. A discharge nozzle 12 may be positioned adjacent an upper flow exit region and may be configured to direct fluid from the pump into piping, hoses, manifolds, processing equipment, or another downstream system. Discharge nozzle 12 may be laterally oriented as shown in FIG. 1A, although other discharge orientations may be used. The pump may further include a driver adapter 13 configured to mechanically couple shaft 2 or an upper shaft section to a motor or other rotary driver. In the illustrated arrangement, an electric motor 14 may be mounted at an upper end of vertical turbine pump 100 and may deliver rotational energy through driver adapter 13 to the rotating shaft system. Electric motor 14 may be substituted with another driver such as an engine, gearbox output, turbine drive, belt-driven arrangement, hydraulic motor, or other rotary power source.

Intermediate shaft sections 15 and intermediate column sections 16 may be used where installation depth, structural requirements, or pump length call for extension between the lower hydraulic assembly and the upper drive assembly. As shown in FIG. 1B, intermediate shaft 15 may comprise one or more shaft segments aligned with shaft 2 to continue transmission of torque along the vertical axis of vertical turbine pump 100. Intermediate column 16 may comprise one or more surrounding structural sections configured to house or protect the intermediate shaft region and, in some implementations, to define part of the dry column or other internal passage structure. The use of intermediate shaft 15 and intermediate column 16 may allow the pump to be modular in length, thereby accommodating different well depths, water table conditions, or installation constraints. In some implementations, vertical turbine pump 100 may be formed from a single continuous body without separate intermediate sections. In other implementations, multiple modular sections may be joined together with flanged interfaces, threaded couplings, clamped couplings, sleeves, or other interconnection structures. The modular nature of intermediate shaft 15 and intermediate column 16 may permit a common lower pumping assembly to be adapted for different field conditions without redesign of the entire pump.

Referring particularly to FIG. 1A, the external side elevation view may illustrate the overall vertical arrangement of vertical turbine pump 100 and may show how the upper drive region, discharge region, support plate region, intermediate body region, and lower bowl region may be aligned along a common axis. FIG. 1A may also demonstrate that the lower pumping assembly may be positioned below soleplate 11 and below discharge nozzle 12, while the upper motor 14 and driver adapter 13 may be positioned above the fluid exit region. The external profile shown in FIG. 1A may vary according to installation depth, capacity, pressure rating, or manufacturing design. In some implementations, the body of vertical turbine pump 100 may have a generally cylindrical or tapered outer profile, and the lower end may include a bell-shaped or flared intake portion that facilitates fluid entry from a submerged source. The external configuration shown in FIG. 1A may represent one non-limiting example of a vertical turbine pump arrangement in which the lower hydraulic portion is submerged and the upper drive region remains accessible above grade or above a mounting surface. FIG. 1A may also illustrate the general relationship of line A-A to the sectional depiction shown in FIG. 1B.

Referring again to FIG. 1B, the sectional side view may illustrate internal relationships between hydraulic components and dry-support components of vertical turbine pump 100. Shaft 2 may extend centrally through impeller 1, mechanical seal 3, dry column 4, and upper coupling regions. Roller bearings 5 may be disposed within dry column 4 in positions selected to support rotation of shaft 2 and to maintain desired alignment between impeller 1 and surrounding structures. In some implementations, the lower roller bearing may be positioned relatively close to mechanical seal 3 and the lower impeller region in order to provide support near the primary hydraulic load location. An upper roller bearing may be spaced upwardly from the lower roller bearing to stabilize shaft 2 over a longer support span. Additional bearings may also be provided. The spacing, number, and type of roller bearings 5 may be selected according to expected radial loads, axial thrust, shaft speed, pump size, and desired service interval. The use of roller bearings 5 in dry column 4 may allow tighter control over shaft runout and impeller positioning than conventional water-lubricated journal bearings, which may in turn reduce hydraulic inefficiencies and unintended contact between moving and stationary components.

FIG. 2 may provide an enlarged or more focused perspective sectional illustration of a lower vertical turbine assembly according to one implementation of the present invention. In FIG. 2, the relationship among impeller 1, shaft 2, mechanical seal 3, dry column 4, roller bearings 5, impeller bowl 6, and surrounding lower pump structure may be more readily appreciated. The perspective sectional view may show that mechanical seal 3 may be disposed directly behind the impeller region and may establish a boundary between the pumped-fluid chamber below and the isolated dry-support region above. Roller bearings 5 may be located in the dry-support region defined by dry column 4 so that shaft 2 may rotate within a supported and substantially isolated environment. FIG. 2 may additionally show the surrounding bowl geometry and upward fluid passage structure that may cooperate with impeller 1 and diffuser-related surfaces to move fluid upwardly while avoiding direct exposure of the bearings to the pumped fluid. The view of FIG. 2 may therefore illustrate in a particularly clear manner the separation between the fluid path and the rolling-element support path that may characterize the present invention.

During operation, vertical turbine pump 100 may be installed such that the lower intake region and impeller bowl 6 are submerged within a fluid source. Electric motor 14 or another driver may rotate shaft 2 through driver adapter 13 and any intermediate shaft components 15. Rotation of shaft 2 may rotate impeller 1, which may induce fluid to enter the lower intake region and may accelerate the fluid upwardly within the hydraulic passage defined by the lower bowl and diffuser structures. Mechanical seal 3 may inhibit the pumped fluid from entering dry column 4 while shaft 2 passes through the sealed interface. Roller bearings 5 may support shaft 2 within dry column 4 so that shaft rotation occurs with reduced friction and improved positional stability relative to conventional water-exposed journal-bearing systems. Fluid discharged from impeller 1 may pass into diffuser 9 and optionally through straightener 10 before continuing upwardly toward discharge nozzle 12. The bearing region may therefore remain substantially isolated while fluid transport occurs through separate surrounding passages. This mode of operation may reduce contamination of the bearing environment and may allow use of bearing technologies that provide improved load capacity and alignment precision.

The advantages associated with vertical turbine pump 100 may arise from the interaction of mechanical seal 3, dry column 4, and roller bearings 5. Conventional vertical turbine pumps may expose bearings directly to pumped water, which may lead to inconsistent lubrication, increased friction, abrasive wear, corrosion, mineral deposition, and reduced alignment control. In contrast, the illustrated arrangement may isolate the bearing region from pumped water and may thereby permit the use of one or more roller bearings 5 in a controlled environment. The roller bearing arrangement may support radial loads, axial loads, or a combination thereof. Because rolling-element contact may reduce friction relative to sliding journal interfaces, the pump may operate with lower energy losses. Improved positional support of shaft 2 may also maintain more stable impeller-to-bowl clearances, which may improve hydraulic efficiency and reduce component wear. The use of dry column 4 may further permit use of lubrication types and bearing materials not suited for direct water exposure. These advantages may collectively contribute to improved durability, reduced maintenance intervals, and improved long-term operating consistency.

The present invention is not limited to the precise component arrangement illustrated in FIGS. 1A-2. In some implementations, multiple impellers 1 may be arranged in series along shaft 2 to form a multi-stage vertical turbine pump. In such implementations, additional diffusers 9 and associated hydraulic passages may be provided between stages, while dry column 4 and bearing-support features may extend through or alongside the staged arrangement as appropriate for the design. In some implementations, mechanical seal 3 may be duplicated or supplemented with additional sealing structures to enhance isolation of the dry bearing region. In some implementations, roller bearings 5 may be preassembled in a cartridge module that may be inserted into the pump body as a unit. In other implementations, individual roller bearings may be mounted separately and may be clamped or secured with threaded fasteners. The dry column may be formed within a discrete bearing housing, a structural support tube, an internal sleeve, or an integrated portion of intermediate column 16. The arrangement may also be adapted for different driver locations, discharge orientations, pump diameters, and installation depths.

Materials of construction for vertical turbine pump 100 may vary widely. Impeller 1 may be formed from cast metal, machined metal, polymeric composite, stainless steel, bronze, duplex alloy, or another material suitable for hydraulic loading and fluid compatibility. Shaft 2 and intermediate shaft 15 may be formed from steel or other high-strength materials selected to resist torsional loading and corrosion. Mechanical seal 3 may use ceramic faces, carbon faces, elastomeric secondary sealing elements, metallic springs, or other known seal materials. Roller bearings 5 may use hardened steel races and rolling elements, ceramic rolling elements, corrosion-resistant alloys, polymer cages, sealed bearing architectures, or hybrid combinations thereof. Impeller bowl 6, diffuser 9, straightener 10, soleplate 11, discharge nozzle 12, driver adapter 13, and intermediate column 16 may likewise be formed from materials chosen based on pressure demands, corrosion conditions, manufacturing cost, weight targets, and expected service environment. No specific material selection is required unless expressly recited elsewhere.

Assembly of vertical turbine pump 100 may occur in a staged manner. Impeller 1 may be coupled to shaft 2 in the lower assembly. Mechanical seal 3 may then be positioned to establish the boundary of dry column 4. Roller bearings 5 may be installed within dry column 4 and may be secured by clamped retention, threaded retention, press-fit retention, cartridge retention, or another retention strategy. Diffuser 9 and optional straightener 10 may be arranged to manage upward flow. One or more intermediate columns 16 and intermediate shafts 15 may be connected as needed to achieve desired length. Soleplate 11, discharge nozzle 12, driver adapter 13, and motor 14 may be mounted at the upper end. When installed, the soleplate may secure the assembly relative to a rigid support structure, and the lower bowl region may be located in the fluid source. Service or replacement of wear rings 7, 8, roller bearings 5, or mechanical seal 3 may be performed according to design-specific procedures. In some implementations, the dry-column and roller-bearing arrangement may simplify maintenance by reducing water-induced degradation of the bearing-support components.

The present invention may also be described in terms of fluid isolation and shaft support relationships. Vertical turbine pump 100 may include a pumped-fluid region in fluid communication with the intake, impeller 1, diffuser 9, straightener 10, and discharge nozzle 12. Vertical turbine pump 100 may further include a dry-support region in which shaft 2 is supported by one or more roller bearings 5. Mechanical seal 3 may define or help define the boundary between those regions. Dry column 4 may extend through part of the lower pump body, part of an intermediate column, or multiple sections of the pump. The pumped-fluid region and the dry-support region may be adjacent to one another in certain locations but may remain isolated by seal structures and surrounding housings. This separated-region architecture may be implemented in different vertical turbine pump configurations without departing from the broader concept of supporting a rotating shaft with roller bearings in an isolated region rather than in a pumped-fluid-lubricated environment.

Although FIG. 1B shows repeated instances of certain reference numerals, such repeated callouts may indicate distributed portions of the same functional structure. For example, dry column 4 may extend along multiple aligned regions through which shaft 2 passes, and roller bearings 5 may be positioned at multiple support locations within that isolated region. The figures are schematic in nature and may omit certain fasteners, housings, lubrication features, vents, couplings, or other secondary details for ease of illustration. Likewise, the proportions, relative lengths, and component shapes shown in FIGS. 1A-2 are illustrative only. Components may be enlarged, reduced, simplified, or rearranged in alternative implementations. The invention may therefore encompass pumps having different external forms, different lower bowl contours, different intermediate section lengths, different seal locations, and different bearing-support arrangements, provided that the pump may utilize the disclosed concept of isolating a bearing region from pumped fluid and supporting the rotating shaft using one or more roller bearings within that isolated region.

Accordingly, the detailed description of FIGS. 1A, 1B, and 2 may demonstrate that vertical turbine pump 100 may comprise a bowl assembly with impeller 1, a shaft arrangement comprising shaft 2 and optionally intermediate shaft 15, a seal arrangement comprising mechanical seal 3, an isolated bearing-support region comprising dry column 4, a rolling-element support arrangement comprising one or more roller bearings 5, a lower hydraulic containment region comprising impeller bowl 6 and optional wear rings 7, 8, an upward flow-management arrangement comprising diffuser 9 and optional straightener 10, and an upper mounting and drive arrangement comprising soleplate 11, discharge nozzle 12, driver adapter 13, motor 14, and optionally intermediate column 16. These features may cooperate to provide a vertical turbine pump architecture in which pumped fluid is lifted through the pump while the shaft-support bearings remain substantially isolated from the pumped fluid. The present invention may thereby provide improved load-bearing capability, reduced friction, improved shaft alignment, reduced wear, lower power consumption, longer operating life, and broader adaptability to different installation environments as compared with conventional water-lubricated vertical turbine pump systems.

In some implementations, the vertical turbine pump may be configured with more than one impeller arranged along a common shaft in order to provide a multi-stage pumping arrangement capable of generating increased head. In such implementations, each stage may be associated with a corresponding bowl, diffuser, or flow-directing structure, and the isolated bearing region may extend through part or all of the multi-stage assembly. The seal arrangement may be positioned at a lower region of the pump, at an intermediate region of the pump, or at multiple locations depending on the desired separation between pumped fluid and the bearing-support environment. The roller bearing arrangement may likewise vary and may comprise a single roller bearing, a pair of spaced roller bearings, or multiple roller bearings distributed along the shaft to accommodate different radial and axial loading conditions. In certain implementations, the pump may be configured for water service, while in other implementations the pump may be adapted for brackish fluid, chemically aggressive fluid, solids-bearing fluid, slurry-containing fluid, or other pumped media requiring selected materials and internal clearances suited to the intended environment.

In further implementations, the pump may be adapted for different installation formats, discharge configurations, and drive systems without departing from the broader inventive concept. For example, the upper drive portion may be coupled to an electric motor, engine, gearbox, turbine drive, belt-driven system, or other rotary power source, and the discharge region may be oriented laterally, upwardly, or in another direction suited to the surrounding piping arrangement. The dry bearing region may be formed within a dedicated bearing housing, an internal sleeve, a structural support column, or an integrated portion of the pump body, and the seal arrangement may comprise a mechanical seal, cartridge seal, segmented seal, multiple-stage seal arrangement, or other sealing structure configured to inhibit fluid ingress. The pump may further be scaled for shallow installations, deep-well applications, municipal systems, industrial processes, agricultural irrigation, or other service conditions in which improved shaft support and isolation of the bearing environment may be beneficial. Accordingly, the illustrated embodiments are representative only, and additional configurations, component arrangements, material selections, and structural variations may be used consistent with the scope of the present invention.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A vertical turbine pump comprising:
a bowl assembly configured to be positioned in a fluid source;
an impeller assembly disposed in the bowl assembly;
a shaft coupled to the impeller assembly and extending upwardly therefrom;
a column assembly extending upwardly from the bowl assembly;
a bearing housing disposed within the vertical turbine pump and defining a bearing region through which the shaft extends;
at least one roller bearing positioned within the bearing region and configured to rotatably support the shaft; and
a seal assembly arranged between the bearing region and the bowl assembly, the seal assembly being configured to inhibit pumped fluid from entering the bearing region;
wherein rotation of the shaft drives the impeller assembly to pump fluid through the bowl assembly while the at least one roller bearing supports the shaft within the bearing region and the seal assembly maintains the bearing region in a substantially dry condition.

2. The vertical turbine pump of claim 1, wherein the seal assembly comprises a mechanical seal.

3. The vertical turbine pump of claim 2, wherein the mechanical seal is positioned adjacent the impeller assembly.

4. The vertical turbine pump of claim 1, wherein the bearing housing and the seal assembly cooperate to define a dry column within the vertical turbine pump.

5. The vertical turbine pump of claim 1, wherein the at least one roller bearing comprises a plurality of roller bearings positioned within the bearing region.

6. The vertical turbine pump of claim 5, wherein the plurality of roller bearings includes an upper roller bearing and a lower roller bearing spaced from one another along the shaft.

7. The vertical turbine pump of claim 5, wherein the plurality of roller bearings are clamped in place within the bearing region.

8. The vertical turbine pump of claim 5, wherein the plurality of roller bearings are secured within the bearing region by one or more threaded fasteners.

9. The vertical turbine pump of claim 1, wherein the seal assembly is configured to isolate the bearing region from pumped water during operation of the vertical turbine pump.

10. The vertical turbine pump of claim 1, wherein the bearing region is free of water-lubricated journal bearings.

11. The vertical turbine pump of claim 1, wherein the at least one roller bearing is configured to support radial loads imparted to the shaft during operation of the vertical turbine pump.

12. The vertical turbine pump of claim 1, wherein the at least one roller bearing is configured to support axial loads and radial loads imparted to the shaft during operation of the vertical turbine pump.

13. The vertical turbine pump of claim 1, wherein the at least one roller bearing is configured to maintain positional control of the shaft and the impeller assembly during operation of the vertical turbine pump.

14. The vertical turbine pump of claim 1, wherein the bowl assembly comprises an impeller bowl configured to inhibit recirculation of fluid into a suction side of the impeller assembly.

15. The vertical turbine pump of claim 1, further comprising a diffuser positioned to receive fluid discharged from the impeller assembly.

16. The vertical turbine pump of claim 15, further comprising a straightener positioned above the diffuser and configured to smooth upward fluid flow through the vertical turbine pump.

17. The vertical turbine pump of claim 1, wherein the column assembly comprises one or more modular column sections configured to accommodate different installation depths.

18. The vertical turbine pump of claim 1, further comprising a driver adapter configured to couple the shaft to a motor.

19. A vertical turbine pump comprising:
a bowl assembly configured to be positioned in a fluid source;
an impeller assembly disposed in the bowl assembly;
a shaft coupled to the impeller assembly and extending upwardly therefrom;
a column assembly extending upwardly from the bowl assembly;
a bearing housing positioned above the bowl assembly and defining a dry column through which the shaft extends;
an upper roller bearing and a lower roller bearing positioned within the dry column and spaced from one another along the shaft, the upper roller bearing and the lower roller bearing being configured to rotatably support the shaft; and
a mechanical seal positioned between the bowl assembly and the dry column and disposed about the shaft, the mechanical seal being configured to inhibit pumped fluid from entering the dry column;
wherein rotation of the shaft drives the impeller assembly to pump fluid upwardly through the bowl assembly while the upper roller bearing and the lower roller bearing support the shaft within the dry column in a substantially dry condition.

20. A method of operating a vertical turbine pump, the method comprising:
positioning a bowl assembly and an impeller assembly in a fluid source;
rotating a shaft coupled to the impeller assembly to drive the impeller assembly and thereby pump fluid upwardly through the vertical turbine pump;
rotatably supporting the shaft with at least one roller bearing positioned within a bearing region of the vertical turbine pump; and
inhibiting pumped fluid from entering the bearing region with a seal assembly arranged between the bearing region and the bowl assembly such that the at least one roller bearing remains in a substantially dry condition during operation of the vertical turbine pump.
